(19) United States
(12) Patent Application Publication
(10) Pub. No.: US 2003/0079637 A1
(43) Pub. Date: May 1, 2003

(54) Monitoring print media advance in hardcopy apparatus

(76) Inventors: David Claramunt, Barcelona (ES); Carles Flotats, Barcelona (ES); Martin Urrutia, Barcelona (ES)

Correspondence Address: HEWLETT-PACKARD COMPANY, Intellectual Property Administration, P.O. Box 272400, Fort Collins, CO, 80527-2400, US

(21) Appl. No.: 09/984,570

(22) Filed: Oct. 30, 2001

(51) Int. Cl. B41F 13/24; B41F 1/54; B41F 33/00

(52) U.S. Cl. 101/484; 101/232

(57) ABSTRACT

The advance of a print media through a hardcopy apparatus is monitored by a separate wheel meeting in contact with the print media surface. An encoder disc is mounted coaxially with the wheel, and its rotary position is detected in non-contact making manner.

### FIELD OF THE INVENTION

The present invention relates to monitoring print media in hardcopy apparatus, for example monitoring the print media advance in printing devices.

### BACKGROUND OF THE INVENTION

In hardcopy apparatus, the problem arises of feeding media across a printing platen with accurate positioning. In order that ink can be deposited on the media precisely by one or more printheads, the media needs to be advanced between printing swaths by the correct amount. If the print media is advanced too much, gaps can occur between adjacent swaths. If the print media is insufficiently advanced, the ink in adjacent swaths overlaps. Both these effects lead to a deterioration in print quality.

In existing hardcopy apparatus, for example ink-jet printers, the print media advance positioning is monitored by monitoring the angular position of a media feed roller.

Taking into account the media thickness, the roller is then rotated through a calculated angle with the aim of moving the media by a desired distance into a desired position.

U.S. Pat. No. 5,774,074 discloses one example of a position encoder system which detects the angular position of a feed roller of an ink-jet printer.

A problem with using a feed roller position to monitor a print media position is that slippage can occur between the non-printing surface of the print media and the surface of the roller. Thus the position of the roller is no longer an accurate representation of the position of the media. Attempts have been made to eliminate these errors by making prints with the apparatus and calculating the slippage which has occurred by measuring the resulting imperfections in the prints. However, it is not possible to accurately characterize these imperfections, and errors still remain in the print media positioning. Factors which prevent the accurate positioning by affecting the coefficient of friction between the media and the roller include the ambient humidity, the variability of the media from batch to batch, the presence of dust or dirt on the roller surface and degradation of the roller surface with age and use.

Another problem arising with use of the feed roller position is the existence of mechanical imperfections in the feeding mechanism. For example, there may be imperfections and variations in the roller runout and cylindricity, the transmission geometry and flexibility and/or the motor detent torque. Although compensation can be made for some of these errors, even this compensation process can introduce further errors, and in any case further time and effort need to be expended.

### SUMMARY OF THE INVENTION

Certain aspects of the present invention seek to overcome or reduce one or more of the above problems.

According to a first aspect of the present invention there is provided a print media advance arrangement for a hardcopy apparatus comprising one or more rollers for feeding print media along a media path, wherein means are provided for monitoring the position of the media as it moves along said path, said monitoring means comprising at least one wheel, said wheel being arranged to engage the media surface, so that movement of the media along said path causes rotation of said wheel, and said monitoring arrangement carrying indicia, said indicia rotating when said wheel rotates, and means arranged to detect said rotation of said indicia in non-contact making manner and to produce a signal representing the position of the media.

The term “wheel” is used herein in the same sense as in the expression “pinch wheel”, viz it is intended to embrace wheels of substantial longitudinal axial extent which are also termed rollers.

In preferred arrangements the wheel engages the surface of the print media tangentially, i.e. there is no angle of wrap around the wheel. This means there are virtually no forces imposed on the wheel which would cause it to slip relative to the print media.

In preferred arrangements the said wheel is fixed substantially coaxially on a rotatable shaft, and the arrangement further comprises an encoder disc fixed substantially coaxially on said shaft, said encoder disc carrying said indicia. The indicia are preferably optical. Alternatively they may be capacitative or magnetic or detectable in other non-contact making manner.

According to a second aspect of the present invention, there is provided a device for monitoring print media advance in a hardcopy apparatus, the device comprising a wheel, said wheel being rotatably mounted, said wheel having a circumferential surface, said surface being arranged to engage tangentially the surface of the print media as it advances through the hardcopy apparatus, the device including indicia which rotate with said wheel, and means for reading said indicia in a non-contact making manner.

According to a third aspect of the present invention, there is provided a method of monitoring the advance of print media as of advances through a hardcopy apparatus comprising means for advancing the media along a media path, the method comprising the use of at least one detector to monitor the position of the print media, the or each detector being separate from said media advancing means.

Since the detector is not a part of the media advancing means, it provides “actual” information rather than “desired” information which can be incorrect due to slippage between the print media and the detector or due to imperfections in the media advancing means.

Preferably a test printing operation is undertaken and the results are taken into account to remove residual errors from print media advance indications in subsequent printing operations. This increases the accuracy of the indication of media advance. The detector provides an output which is used as a feedback signal to control the advance of the media along said media path so that the print media is in the correct position for a subsequent operation, e.g. printing a swath across the print media, or cutting the print media.

### BRIEF DESCRIPTION OF THE DRAWINGS

Preferred embodiments of the present invention will now be described, by way of example only, with reference to the accompanying drawings, of which:

FIG. 1 is a perspective view of an arrangement for monitoring print media movement in accordance with a first embodiment of the present invention;

FIG. 2 is an enlarged view of a friction wheel of the arrangement of FIG. 1;

FIG. 3 is an enlarged view of an alternative friction wheel for use in the arrangement of FIG. 1; and

FIG. 4 is a front view of an arrangement for monitoring print media movement in accordance with a second embodiment of the present invention.

### DETAILED DESCRIPTION OF PREFERRED EMBODIMENTS

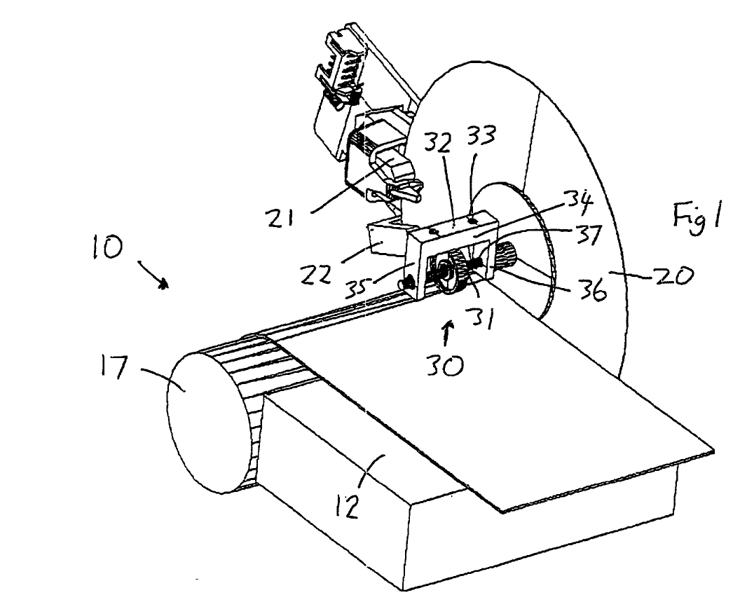

Referring to the drawings, FIG. 1 shows a partly-sectional view of the print media feeding mechanism 10 of an ink-jet printer. Print media 11 is moved over a print zone 12 by a media feed roller 17.

In existing arrangements, such as those disclosed in U.S. Pat. No. 5,774,074, a position encoder disc is connected to the media feed roller and arranged substantially coaxially therewith. In the arrangement of FIG. 1, however, a rotary position encoder disc 20 is instead amounted coaxially with a friction wheel 31 of a print media movement monitoring arrangement 30, which will now be described in detail.

The monitoring arrangement 30 is located over the upper surface of the print media 11 at a location where its lower surface is engaged by roller 12. The arrangement 30 comprises a holder in the form of a yoke 32 which is attached to a fixed part (not shown) of the printer by means of spring-loaded mountings incorporating bolts passing through attachment holes 33 in a web portion 34 of the yoke. Arms 35, 36 of the yoke have holes for receiving a shaft 37. A friction wheel 31, which can be made of rigid rubber or plastics material, is substantially-coaxially mounted on shaft 37, at a substantially central location between arms 35, 36. The wheel 31 is fixed relative to shaft 37.

One end of shaft 37 projects beyond arm 36 and position encoder disc 20 is mounted substantially coaxially thereon. Disc 20 has two concentric rows of markings applied circumferentially thereto one of which includes a unique marker “flag”. The markings are read by respective sensing heads 21, 22 to monitor the relative and absolute orientation of the disc 20. The heads 21, 22 supply position signals to a central processing unit of the printer to enable the media advance to be controlled.

To substantially eliminate slippage between the surface of media 11 and friction wheel 31, it is desirable that there is a good frictional engagement between them. Friction depends on both the coefficient of friction between the engaging surfaces and the normal load between the surfaces. Wheel 31 provides a satisfactorily high coefficient of friction. The normal load is affected by the weight of the monitoring arrangement 30 and disc 20 and also the loads applied by the springs associated with the mounting bolts. The latter factor is usually the greater, since increased weight involves higher inertia, and in order for the monitoring arrangement to respond quickly and accurately to movements of the print media 11, it should have relatively low inertia.

Prior to use, the friction wheel 31 and the encoder disc 20 are calibrated to take into account the ratio of their diameters so as to be able to relate the angle of rotation of disc 20 to the linear distance of advance of the print media. Calibration is also undertaken to take account of any eccentricity of the arrangement. In use to advance media 11, the printer software modifies the desired position instructions to the media feed mechanism to take into account the determined calibration data.

An advantage of the above-described monitoring arrangement is that the movement and position of the print media is monitored directly and, in particular, independently of the media feed mechanism. Wheel 31 operates completely independently from media feed roller 17. Thus an efficient feedback loop is provided in that the media advance instructions supplied to the media feed mechanism take into account the actual position of the print media as supplied by disc 20. The use of this actual position signal means that media slippage and any eccentricities in the media feed mechanism are automatically taken into account. The effects of the uncontrollable influences are also eliminated, such as variations in print media, ambient humidity, and dirt on the roller surface.

A good frictional engagement is provided between the friction wheel 31 and the media 11. In addition, the combined weight of monitoring arrangement 30 and the encoder disc 20 is relatively light so that it has a negligible effect on the print media and monitors the movements of the media quickly and precisely.

The rigidity of wheel 31 ensures that it does not deform thus avoiding false readings.

The components of arrangement 30 are simple and cheap and thus a low cost mechanism can be implemented. Moreover, a relatively cheap media feed mechanism may be employed, since high positional accuracy for this mechanism is no longer required.

The positioning of arrangement 30 adjacent the feed roller 17 has the advantage that the print media position is well-controlled here. In addition, it is close to the print zone 12 which is precisely where accuracy of position is required. By positioning the arrangement 30 adjacent to the media input to the print zone 12, i.e. before the media is printed, the effects of any expansion of the media after printing (i.e. cockle) are eliminated.

Various modifications can be made to the above-described arrangement. For example, one or more wheels 31 may be fixed to shaft 37, whether spaced therealong or immediately adjacent to each other.

Wheel 31 may be provided with a coating on its cylindrical surface with a thin covering of soft rubber or other high friction material. A thick covering of soft rubber or a tire are not as suitable, since substantial deformation of the wheel surface could also adversely affect the indication of position.

The wheel 31 may have spokes or another open configuration so as to save weight.

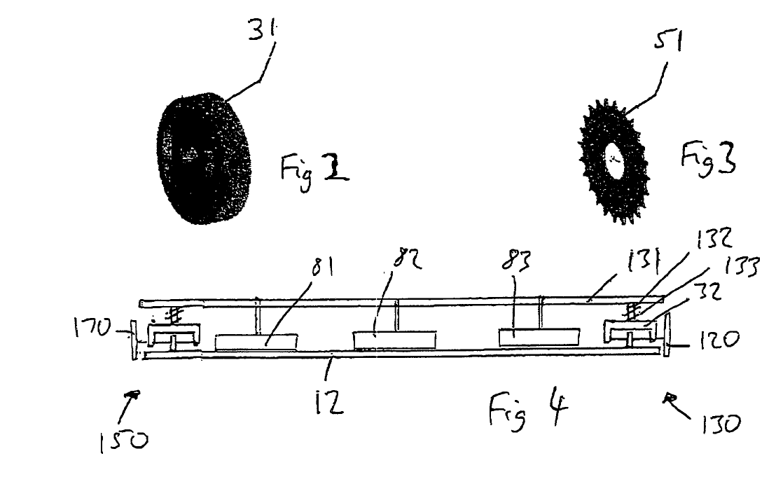

Other wheels with a light friction rim may be used as the friction wheel. For example, FIG. 3 shows a star wheel 51, which may be used as the friction wheel. The points of star wheel 51 provide a satisfactorily high coefficient of friction. Wheel 51 may also have spokes or other open configuration.

As with wheel 31, a plurality of star wheels 51 may be fixed to shaft 37. The points of the stars on the various wheels may be circumferentially staggered, which serves to reduce non-linearities in the rotation of the star wheels due to their non-uniform circumference. Instead of projections with pointed ends, the star wheel(s) may have projections with rounded ends.

The star wheel may be made of any suitable metal, such as steel, or of hard-wearing plastics material.

Instead of being mounted on a yoke 32, one or more friction wheels 31 may be mounted on one or more respective arms attached to the printer.

In another modification, the mounting arrangement 30 is mounted on an arm pivotally-mounted on a fixed part of the printer. Here, the load effecting the frictional engagement depends on the weight of the arm. Such a mounting arrangement may be similar to that used for pinch wheels.

FIG. 4 shows a mounting arrangement 130 which is located so that the axis of shaft 37 substantially coincides with the axis of pinch wheels 81, 82, 83. Arrangement 130 and its associated encoder disc 120 are attached to a beam 131 or other fixed part of a printer by means of a bolt 132 which is loaded by a spring 133. The force of spring 133 affects the load which the friction wheel 31 exerts on the print media. To allow correct instalment of the arrangement 130 and/or to facilitate the use of different print media 11 having a range of thicknesses, the force exerted by spring 133 may be adjustable in a controlled manner.

The embodiment of FIG. 4 also comprises a second monitoring arrangement 150 and associated encoder disc 170 at the opposite side of the media to arrangement 130. By detecting the outputs of both discs 120 and 170, it can be detected whether the media is advancing further at one side than at the other which would indicate a media misfeed. Corrective action could be taken by adjusting the media feed, or by changing the printing instructions. Alternatively, an indication of unsatisfactory operation could be given to the user. Such an arrangement would be of particular advantage in hardcopy apparatus including a scanner.

In a modification, the monitoring arrangement 150 may be omitted from the system of FIG. 4. Two monitoring arrangements 130, 150 may be employed without the pinch wheels. More than two monitoring arrangements 130, 150 may be provided at spaced positions across the media. This enables accuracy to be increased by obtaining an average from their respective outputs.

In a modification, the monitoring arrangement 30 may engage the print media 11 at a location spaced along the media axis from the media feed roller 17. For example it may be located at the output of the print zone 12, e.g. adjacent to overdrive rollers. This is not so advantageous a location if cockle occurs, but it is quite acceptable for non-absorbent print media such as transparency material. In addition, depending upon the design of the hardcopy apparatus, it may be advantageous to locate the monitoring arrangement 30 remote from media feed roller 17 so that the encoder disc 20 does not impede movements of the carriage carrying the printhead(s).

In another modification, the encoder disc may be omitted and the code markings applied to the friction wheel 31 itself. This provides a compact and lightweight arrangement, but causes a loss of resolution since the markings are much closer to each other.

In another modification the encoder disc 20 is connected to directly to a pinch wheel.

Instead of being detected optically, the position of the friction wheel 31 may be detected by another non-contact making i.e. contactless method, e.g. magnetically or capacitatively. In these cases suitable capacitative or magnetic indicia are provided.

The features of the various described embodiments and their modifications may be interchanged as desired.

The monitoring arrangement may be used in any type of printer. In addition it can be used in other types of hardcopy apparatus, including plotters, scanners, photocopiers and facsimile machines.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A print media advance arrangement for a hardcopy apparatus comprising one or more rollers for feeding print media along a media path, wherein means are provided for monitoring the position of the media as it moves along said path, said monitoring means comprising at least one wheel, said wheel being arranged to engage the media surface, so that movement of the media along said path causes rotation of said wheel, and said monitoring arrangement carrying indicia, said indicia rotating when said wheel rotates, and means arranged to detect said rotation of said indicia in non-contact making manner and to produce a signal representing the position of the media.

2. An arrangement according to claim 1, wherein said wheel engages said media surface tangentially.

3. An arrangement according to claim 1, wherein said wheel is fixed substantially coaxially on a rotatable shaft, and the arrangement further comprises an encoder disc fixed substantially coaxially on said shaft, said encoder disc carrying said indicia.

4. An arrangement according to claim 3, wherein said indicia are optical.

5. An arrangement according to claim 1, wherein said wheel is mounted on a holder, said holder including attachment means arranged to be attached to a fixed part of said hardcopy apparatus.

6. An arrangement according to claim 5, wherein said attachment means are spring-loaded.

7. An arrangement according to claim 6, wherein the load applied by said spring-loaded means is adjustable.

8. A device for monitoring print media advance in a hardcopy apparatus, the device comprising a wheel, said wheel being rotatably mounted, said wheel having a circumferential surface, said surface being arranged to engage tangentially the surface of the print media as it advances through the hardcopy apparatus, the device including indicia which rotate with said wheel, and means for reading said indicia in a non-context making manner.

9. A device according to claim 8, wherein said wheel is fixed substantially coaxially on a rotatable shaft, and the arrangement further comprises an encoder disc fixed substantially coaxially on said shaft, said encoder disc carrying said indicia.

10. A device according to claim 8 further comprising a yoke member including a web portion and two arms at the ends of said web portion, a shaft being rotatably mounted in said arms, and said wheel being fixed substantially coaxially on said shaft, and said web portion including means for fixing said device to a hardcopy apparatus.

11. A device according to claim 10, wherein the arrangement further comprises an encoder disc, said encoder disc being fixed substantially coaxially on said shaft, said encoder disc carrying said indicia.

12. A device according to claim 10, wherein said means for fixing said device to said hardcopy apparatus are spring-loaded.

13. A device according to claim 12, wherein the load applied by said spring-loaded means is adjustable.

14. A method of monitoring the advance of print media as of advances through a hardcopy apparatus comprising means for advancing the media along a media path, the method comprising the use of at least one detector to monitor the position of the print media, the or each detector being separate from said media advancing means.

15. A method according to claim 14, wherein the detector is in the form of a wheel, said wheel being arranged to contact said print media tangentially.

16. A method according to claim 14 comprising detecting the rotary position of said wheel is a non-contact making manner.

17. A method according to claim 14, wherein a test printing operation is undertaken and the results are taken into account to remove residual errors from print media advance indications in subsequent printing operations.

18. A method according to claim 14 wherein the detector provides an output, said output being used to control the advance of the media along said media path so that the print media is in the correct position for a subsequent operation.
